(19) United States
(12) Patent Application Publication
(10) Pub. No.: US 2024/0427912 A1
(43) Pub. Date: Dec. 26, 2024

(54) DATA PROVIDING SYSTEM, DATA PROVIDING APPARATUS, AND DATA PROVIDING METHOD

(71) Applicant: NEC Corporation, Minato-ku, Tokyo (JP)

(72) Inventor: Nobutaka ISHII, Tokyo (JP)

(73) Assignee: NEC Corporation, Minato-ku, Tokyo (JP)

(21) Appl. No.: 18/690,900

(22) PCT Filed: Sep. 28, 2021
(86) PCT No.: PCT/JP2021/035665

§ 371 Date: Mar. 11, 2024

(51) Int. Cl. G06F 21/62

(52) U.S. Cl. CPC G06F 21/62; G06F 2221/2141

(57) ABSTRACT

A data providing system (1) according to the present disclosure includes: an optical fiber sensing unit (10) configured to acquire sensing data by performing optical fiber sensing; a processing unit (21) configured to generate processed data by performing processing on the sensing data; a level imparting unit (22) configured to impart an access level according to a processing stage to each piece of data being included in the sensing data and the processed data; and a data providing unit (24) configured to provide each piece of the data to a customer related to the access level.

### TECHNICAL FIELD

The present disclosure relates to a data providing system, a data providing apparatus, and a data providing method.

### BACKGROUND ART

A technique of acquiring data by performing optical fiber sensing is known. Further, a technique of generating other data by processing the acquired data is known. The generated data are used for a predetermined purpose (for example, see Patent Literature 1).

In the technique described in Patent Literature 1, when a person or a vehicle passes through a gate, optical fiber sensing is performed, and thereby acquiring data indicating vibration generated by walking of the person or traveling of the vehicle after passing through the gate. In the technique described in Patent Literature 1, the acquired data are processed and thereby data indicating a behavior pattern of the person or the vehicle after passing through the gate are generated. The generated data are used for monitoring the behavior of the person or the vehicle after passing through the gate.

As another related art, a technique related to data management described in Patent Literature 2 is also known.

### CITATION LIST

### Patent Literature

[Patent Literature 1] International Patent Publication No. WO2020/202694
[Patent Literature 2] Japanese Unexamined Patent Application Publication No. 2020-046920

### SUMMARY OF INVENTION

### Technical Problem

Incidentally, it is suitable that data acquired by performing optical fiber sensing (i.e., unprocessed data) and data generated by processing the acquired data (i.e., processed data) are provided according to convenience (request) of a customer. For example, it is suitable that, among unprocessed and processed data, unprocessed data are provided to a customer requesting unprocessed data. On the other hand, it is suitable that, among unprocessed and processed data, processed data are provided to a customer requesting processed data.

In other words, it is suitable that the unprocessed and processed data are provided to related customers. However, in the technique described in Patent Literature 1, it is not assumed that the unprocessed and processed data (in particular, the unprocessed data) are provided to a customer. Therefore, there is a problem that it is difficult to provide the unprocessed and processed data to related customers.

An object of the present disclosure is to solve the above-described problem and provide a data providing system, a data providing apparatus, and a data providing method that are capable of providing unprocessed and processed data to related customers.

### Solution to Problem

A data providing system according to one aspect includes:
an optical fiber sensing unit configured to acquire sensing data by performing optical fiber sensing;
a processing unit configured to generate processed data by performing processing on the sensing data;
a level imparting unit configured to impart an access level according to a processing stage to each piece of data being included in the sensing data and the processed data; and
a data providing unit configured to provide each piece of the data to a customer related to the access level.

A data providing apparatus according to one aspect includes:
a processing unit configured to generate processed data by performing processing on sensing data acquired by performing optical fiber sensing in an optical fiber sensing unit;
a level imparting unit configured to impart an access level according to a processing stage to each piece of data being included in the sensing data and the processed data; and
a data providing unit configured to provide each piece of the data to a customer related to the access level.

A data providing method according to one aspect is a data providing method performed by a data providing apparatus, the data providing method including:
a processing step of generating processed data by performing processing on sensing data acquired by performing optical fiber sensing in an optical fiber sensing unit;
a level imparting step of imparting an access level according to a processing stage to each piece of data being included in the sensing data and the processed data; and
a data providing step of providing each piece of the data to a customer related to the access level.

### Advantageous Effects of Invention

According to the above-described aspects, it is possible to provide a data providing system, a data providing apparatus, and a data providing method that are capable of providing unprocessed and processed data to related customers.

### BRIEF DESCRIPTION OF DRAWINGS

FIG. 1 is a diagram illustrating a configuration example of a data providing system according to a first example embodiment;

FIG. 2 is a diagram illustrating an example of an access level imparted by a level imparting unit according to the first example embodiment;

FIG. 3 is a diagram illustrating an example of an access level imparted by the level imparting unit according to the first example embodiment;

FIG. 4 is a diagram illustrating an example of information regarding an access level for each customer, which is held by a data providing unit according to the first example embodiment;

FIG. 5 is a flowchart illustrating a schematic example of an operation flow of the data providing system according to the first example embodiment;

FIG. 6 is a diagram illustrating a configuration example of a data providing system according to a second example embodiment;

FIG. 7 is a diagram illustrating a configuration example of a data providing system according to a third example embodiment; and

FIG. 8 is a block diagram illustrating a hardware configuration example of a computer that implements a data providing apparatus according to the first to third example embodiments.

### EXAMPLE EMBODIMENT

Hereinafter, example embodiments of the present disclosure will be described with reference to the drawings. Note that the following description and the drawings are omitted and simplified as appropriate for clarity of description. In the following drawings, the same element is denoted by the same reference sign, and redundant descriptions are omitted as necessary.

### First Example Embodiment

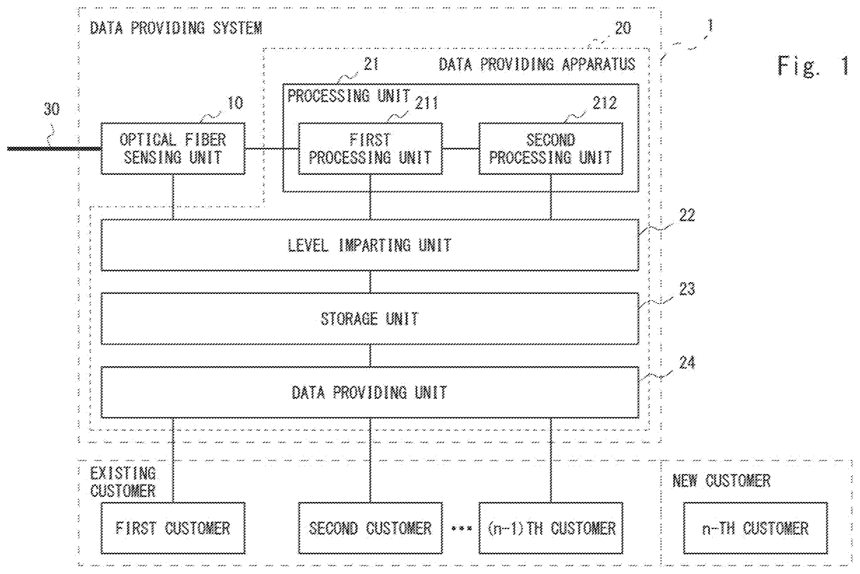

First, a configuration example of a data providing system 1 according to a first example embodiment will be described with reference to FIG. 1.

As illustrated in FIG. 1, the data providing system 1 according to the first example embodiment includes an optical fiber sensing unit 10 and a data providing apparatus 20. The data providing apparatus 20 includes a processing unit 21, a level imparting unit 22, a storage unit 23, and a data providing unit 24.

The optical fiber sensing unit 10 is configured of a distributed fiber optic sensing (DFOS) apparatus (for example, a distributed vibration sensing (DVS) apparatus, a distributed acoustic sensing (DAS) apparatus, or a distributed temperature sensing (DTS) apparatus). The optical fiber sensing unit 10 acquires sensing data by performing DFOS using an optical fiber cable 30. For example, the optical fiber sensing unit 10 acquires vibration data, acoustic data, or temperature data by performing DVS, DAS, or DTS. That is, the sensing data are so-called “raw data”, “flow data”, or the like.

The processing unit 21 performs m (m is an integer of 1 or more) stages of processing on the sensing data acquired by the optical fiber sensing unit 10. FIG. 1 illustrates the processing unit 21 in a case where m is 2, and this processing unit 21 includes a first processing unit 211 and a second processing unit 212.

The processing unit 21 is provided inside the data providing apparatus 20, but may be provided in a cloud network. Further, the level imparting unit 22, the storage unit 23, and the data providing unit 24, which will be described later, may also be provided in a cloud network similar to the cloud network in which the processing unit 21 may be provided.

The first processing unit 211 performs first-stage processing on the sensing data acquired by the optical fiber sensing unit 10. The first-stage processing includes, for example, a process of removing unnecessary data from among the sensing data, a process of detecting occurrence of a predetermined event by using the remaining data (i.e., necessary data) among the sensing data, and a process of generating data indicating a result of the detection. Hereinafter, the data generated by performing the first-stage processing are referred to as “first processed data”.

The second processing unit 212 performs second-stage processing on the first processed data generated by the first processing unit 211. The second-stage processing includes, for example, a process of analyzing the first processed data, and a process of generating data having a higher added value than the first processed data, based on the result of the analysis. Hereinafter, the data generated by performing the second-stage processing are referred to as “second processed data”.

Note that each of the first processing unit 211 and the second processing unit 212 may be configured by a dedicated artificial intelligence (AI). These AIs are generated by prior machine learning.

Hereinafter, the first processed data and the second processed data may be collectively referred to as “processed data”. Further, the sensing data and the processed data may be collectively referred to as “provision candidate data”.

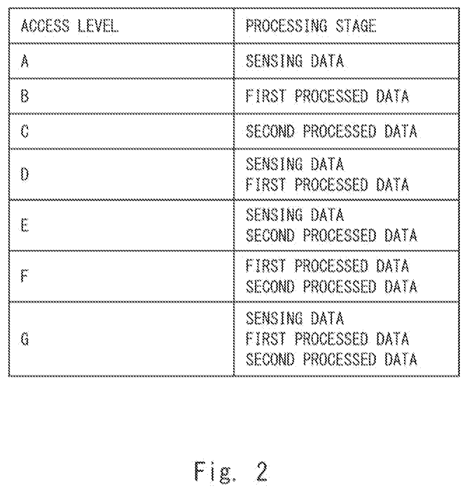

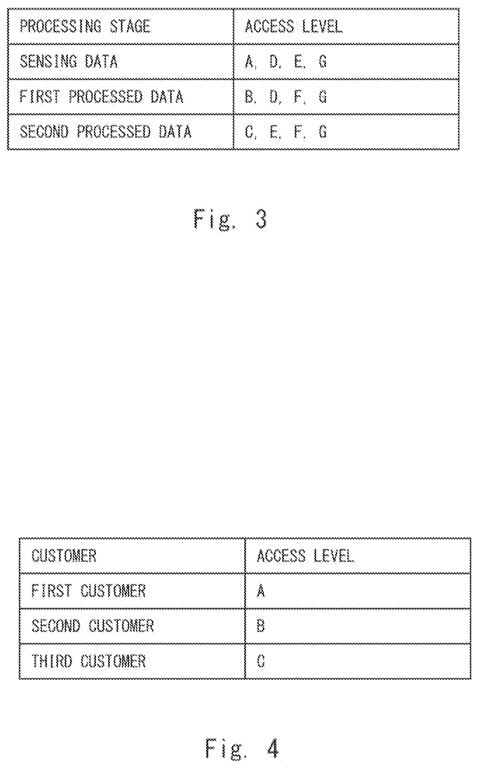

The level imparting unit 22 imparts an access level to each piece of data being included in the provision candidate data, according to a data processing stage (including unprocessed stage) of each piece of data being included in the provision candidate data. Specifically, for example, the level imparting unit 22 imparts an access level [A to G] as illustrated in FIG. 2 to each piece of data being included in the provision candidate data. The example of FIG. 2 illustrates data belonging to an access level for each of the access levels. FIG. 3 is a diagram formed by modifying FIG. 2, and illustrates an access level to which each piece of data belongs for each piece of data.

The storage unit 23 stores the provision candidate data. Note that each piece of data being included in the provision candidate data is stored in the storage unit 23 in a state where a related access level is imparted thereto. For example, in the example of FIGS. 2 and 3, the access levels [A, D, E, and G] are imparted to the sensing data. Therefore, the sensing data are stored in the storage unit 23 in a state where the access levels [A, D, E, and G] are imparted thereto.

The data providing unit 24 provides each piece of data being included in the provision candidate data to a customer assigned with the related access level. Note that providing data to a customer specifically means transmitting data to a customer device (for example, a personal computer, a server, a tablet terminal, a smartphone, a mobile phone, or the like. The same applies hereinafter.)

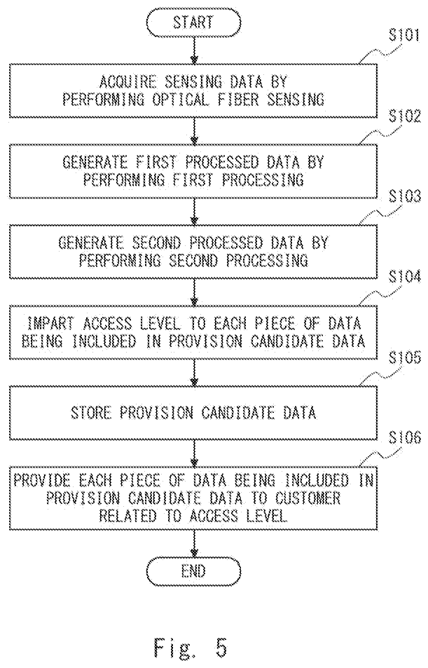

Herein, for an existing customer, as illustrated in FIG. 4, the data providing unit 24 holds, for each customer, information regarding an access level assigned to the customer. In the example of FIG. 4, the access level [A] is set for the first customer, the access level [B] is set for the second customer, and the access level [C] is set for the third customer. In such a case, the data providing unit 24 provides the sensing data among the provision candidate data to the first customer. Further, the data providing unit 24 provides the first processed data among the provision candidate data to the second customer. Further, the data providing unit 24 provides the second processed data among the provision candidate data to the third customer.

Meanwhile, for a new customer, the data providing unit 24 assigns an access level to the new customer, adds information regarding the access level of the new customer to the information in FIG. 4, and then provides the new customer with data related to the access level. However, the function of assigning an access level to a customer is not limited to being included in the data providing unit 24, and may be included in any component other than the data providing unit 24.

It is assumed that the data providing unit 24 provides data to a customer in response to a request from the customer. However, the data providing unit 24 is not limited to this, and may automatically provide data to a customer periodically (for example, every month or the like).

Note that the storage unit 23 is not an essential component in the data providing system 1, and may be provided outside the data providing system 1. That is, the data providing system I may be implemented by a minimum configuration including the optical fiber sensing unit 10, the processing unit 21, the level imparting unit 22, and the data providing unit 24.

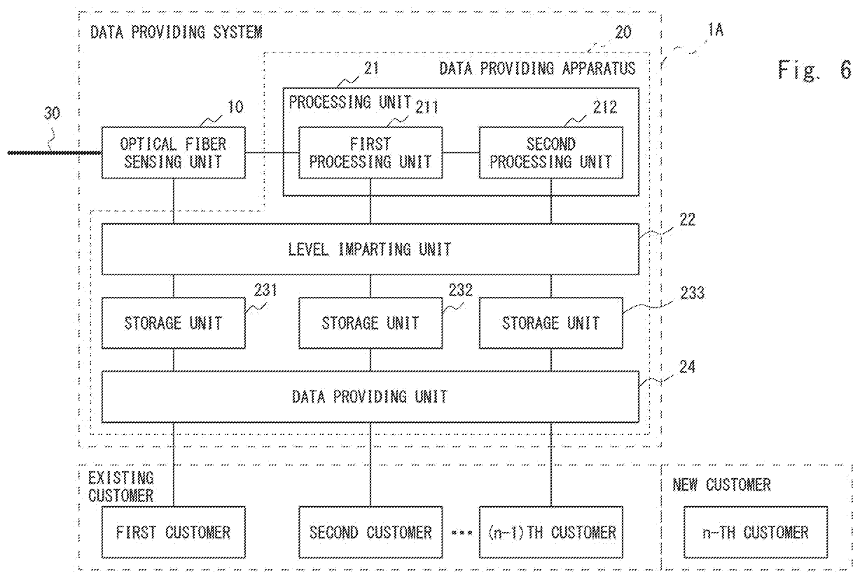

Next, a schematic example of an operation flow of the data providing system 1 according to the first example embodiment will be described with reference to FIG. 5.

As illustrated in FIG. 5, first, the optical fiber sensing unit 10 acquires sensing data by performing DFOS using the optical fiber cable 30 (step S101).

Next, the first processing unit 211 generates first processed data by performing first-stage processing on the sensing data acquired by the optical fiber sensing unit 10 (step S102).

Then, the second processing unit 212 generates second processed data by performing second-stage processing on the first processed data generated by the first processing unit 211 (step S103).

Then, the level imparting unit 22 imparts an access level to each piece of data (sensing data, first processed data, and second processed data) included in provision candidate data (step S104).

Then, the storage unit 23 stores each piece of the data being included in the provision candidate data in a state where the related access level is imparted thereto (step S105).

The processes of steps S101 to S105 described above are performed in advance before providing the data to a customer.

Thereafter, the data providing unit 24 provides each piece of data being included in the provision candidate data to a customer assigned with the related access level (step S106). At this time, for an existing customer, the data providing unit 24 determines the access level assigned to the existing customer, and provides data related to the determined access level. For a new customer, the data providing unit 24 newly assigns an access level to the new customer and provides data related to the assigned access level.

As described above, according to the first example embodiment, the level imparting unit 22 imparts an access level to each piece of data (sensing data and processed data) included in the provision candidate data. The data providing unit 24 provides each piece of data being included in the provision candidate data to a customer assigned with a related access level. Thus, the sensing data and the processed data may be provided to a related customer.

### Second Example Embodiment

Next, a configuration example of a data providing system 1A according to a second example embodiment will be described with reference to FIG. 6.

As illustrated in FIG. 6, the data providing system 1A according to the second example embodiment is different from the data providing system 1 according to the above-described first example embodiment in that the data providing system 1A includes a plurality of storage units 231 to 233. The storage units 231 to 233 correspond to the first to third storage units.

The storage unit 231 is provided in relation to sensing data, and stores the sensing data in a state where a related access level is imparted thereto. The storage unit 232 is provided in relation to first processed data, and stores the first processed data in a state where a related access level is imparted thereto. The storage unit 233 is provided in relation to second processed data, and stores the second processed data in a state where a related access level is imparted thereto.

As described above, the sensing data, the first processed data, and the second processed data may be stored in a related storage unit (that is, a dedicated storage unit) among the plurality of storage units 231, 232, 233.

The configuration of the second example embodiment other than the feature described above is similar to that of the above-described first example embodiment. Therefore, in the second example embodiment, substantially the same operation as that in the above-described first example embodiment is performed, and effects similar to that of the above-described first example embodiment may be achieved. Therefore, a detailed description of the operation and effects of the second example embodiment will be omitted.

### Third Example Embodiment

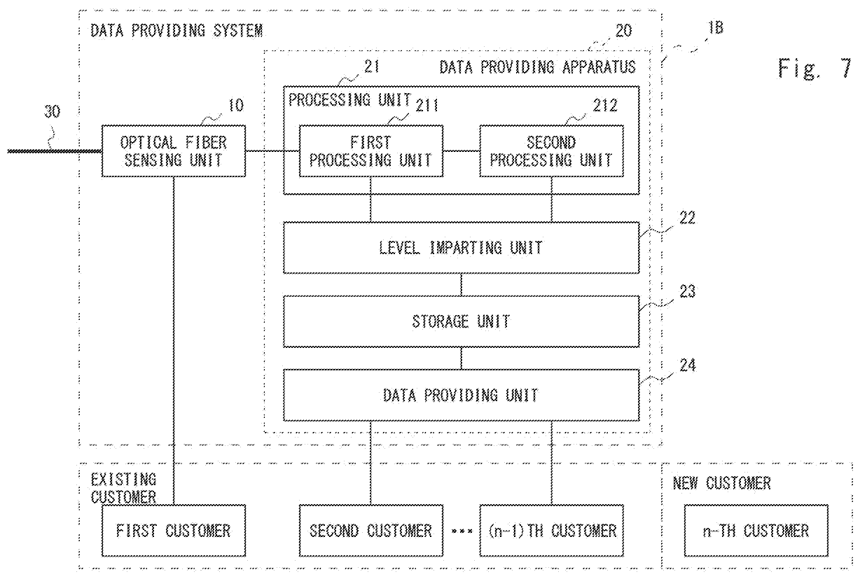

Next, a configuration example of a data providing system 1B according to a third example embodiment will be described with reference to FIG. 7.

As illustrated in FIG. 7, the data providing system 1B according to the third example embodiment is different from the data providing system 1 according to the above-described first example embodiment in the configuration regarding processing of sensing data acquired by an optical fiber sensing unit 10.

That is, in the third example embodiment, a level imparting unit 22 does not impart an access level to the sensing data. Also, the sensing data are not stored in a storage unit 23. Further, the sensing data are directly provided from the optical fiber sensing unit 10 to a specific customer (the first customer in FIG. 1) without passing through the data providing unit 24.

As described above, the sensing data may be provided only to a specific customer, and for other customers, the sensing data are not provided and only processed data may be provided. Further, with the configuration illustrated in FIG. 7, load associated with the processing of the sensing data is reduced.

The configuration of the third example embodiment other than the feature described above is similar to that of the above-described first example embodiment. Therefore, in the third example embodiment, substantially the same operation as that of the above-described first example embodiment is performed, and effects similar to that of the above-described first example embodiment may be achieved. Therefore, a detailed description of the operation and effects of the third example embodiment will be omitted.

### Other Example Embodiments

In the first to third example embodiments described above, in a case where a customer is assigned with a plurality of access levels, the data providing unit 24 may generate a menu for each of the plurality of access levels, the menu indicating data related to the access level from among pieces of data, and present the generated plurality of menus to the customer. Note that presenting a menu to a customer specifically means transmitting a menu to a customer device.

For example, it is assumed that a plurality of access levels [A and B] are assigned to a certain customer. In such a case, the data providing unit 24 generates a menu indicating data related to the access level [A] and a menu indicating data related to the access level [B], and presents the menus to the customer. The customer selects at least one menu of the presented menus. The data providing unit 24 provides the customer with data related to the menu selected by the customer.

In the first to third example embodiments described above, the storage units 23, 231 to 233 are provided at a stage subsequent to the level imparting unit 22, but the positions of the storage units 23, 231 to 233 are not limited thereto. For example, the storage units 23, 231 to 233 may be provided at a stage preceding the level imparting unit 22.

### Hardware Configuration of Data Providing Apparatus According to Example Embodiments

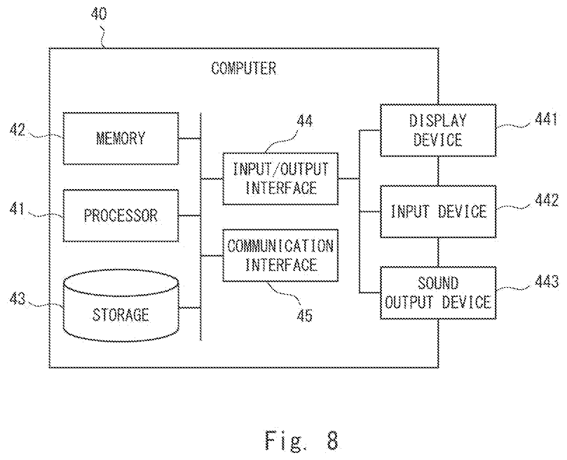

Next, a hardware configuration example of a computer 40 that implements the data providing apparatus 20 according to the above-described first to third example embodiments will be described with reference to FIG. 8.

As illustrated in FIG. 8, the computer 40 includes a processor 41, a memory 42, a storage 43, an input/output interface (input/output I/F) 44, a communication interface (communication I/F) 45, and the like. The processor 41, the memory 42, the storage 43, the input/output interface 44, and the communication interface 45 are connected by a data transmission path for transmitting and receiving data to and from one another.

The processor 41 is, for example, an arithmetic processing device such as a central processing unit (CPU) or a graphics processing unit (GPU). The memory 42 is, for example, a memory such as a random access memory (RAM) or a read only memory (ROM). The storage 43 is, for example, a storage device such as a hard disk drive (HDD), a solid state drive (SSD), or a memory card. The storage 43 may be a memory such as a RAM or a ROM.

The storage 43 stores, for example, a program. Such a program includes instructions (or a software code) for causing, when loaded into a computer, the computer to perform one or more functions of the data providing apparatus 20 described in the above-described first to third example embodiments. The processing unit 21, the level imparting unit 22, and the data providing unit 24 included in the data providing apparatus 20 may be implemented by the processor 41 reading and executing the program stored in the storage 43. Herein, when executing the above-described program, the processor 41 may read the program into the memory 42 and then execute the program, or may execute the program without reading the program into the memory 42. The memory 42 and the storage 43 also serve as the storage units 23, 231 to 233 included in the data providing apparatus 20. Further, the memory 42 and the storage 43 also serve for implementing a function of the data providing unit 24 included in the data providing apparatus 20 to hold information (for example, information in FIG. 4).

In addition, the above-described program may be stored in a non-transitory computer-readable medium or a tangible storage medium. By way of example, and not limitation, the computer-readable media or tangible storage media include RAM, ROM, flash memory, SSD or other memory techniques, compact disc (CD)-ROM, digital versatile disc (DVD), Blu-ray (registered trademark) disc or other optical disk storages, magnetic cassette, magnetic tape, magnetic disk storage or other magnetic storage devices. In addition, the above-described program may be transmitted on a transitory computer readable medium or a communication medium. By way of example, and not limitation, transitory computer-readable media or communication media include electrical, optical, acoustic, or other forms of propagated signal.

The input/output interface 44 is connected to a display device 441, an input device 442, a sound output device 443, and the like. The display device 441 is a device, such as a liquid crystal display (LCD), a cathode ray tube (CRT) display, or a monitor, that displays a screen according to drawing data processed by the processor 41. The input device 442 is a device that receives an operation input from an operator, and is, for example, a keyboard, a mouse, a touch sensor, or the like. The display device 441 and the input device 442 may be integrated and implemented as a touch panel. The sound output device 443 is a device, such as a speaker, that acoustically outputs a sound according to sound data processed by the processor 41.

The communication interface 45 transmits and receives data to and from an external apparatus. For example, the communication interface 45 communicates with an external apparatus via a wired communication path or a wireless communication path.

Although the present disclosure has been described with reference to the example embodiments, the present disclosure is not limited to the above-described example embodiments. Various changes that can be understood by a person skilled in the art can be made to the configuration and details of the present disclosure within the scope of the present disclosure.

For example, some or all of the above-described example embodiments may be used in combination with each other.

In addition, some or all of the above-described example embodiments may be described as the following supplementary notes, but the present invention is not limited thereto.

### Supplementary Note 1

A data providing system comprising:
an optical fiber sensing unit configured to acquire sensing data by performing optical fiber sensing;
a processing unit configured to generate processed data by performing processing on the sensing data;
a level imparting unit configured to impart an access level according to a processing stage to each piece of data being included in the sensing data and the processed data; and
a data providing unit configured to provide each piece of the data to a customer related to the access level.

### Supplementary Note 2

The data providing system according to supplementary note 1, wherein
the processing includes first-stage processing and second-stage processing,
the processing unit includes a first processing unit configured to generate first processed data by performing the first-stage processing on the sensing data, and a second processing unit configured to generate second processed data by performing the second-stage processing on the first processed data, and
the processed data include the first processed data and the second processed data.

### Supplementary Note 3

The data providing system according to supplementary note 2, further comprising a storage unit configured to store the sensing data, the first processed data, and the second processed data.

### Supplementary Note 4

The data providing system according to supplementary note 3, wherein the storage unit stores the sensing data, the first processed data, and the second processed data in a state where the related access levels are imparted.

### Supplementary Note 5

The data providing system according to supplementary note 2, further comprising:
a first storage unit configured to store the sensing data;
a second storage unit configured to store the first processed data; and
a third storage unit configured to store the second processed data.

### Supplementary Note 6

The data providing system according to supplementary note 5, wherein
the first storage unit stores the sensing data in a state where the related access level is imparted,
the second storage unit stores the first processed data in a state where the related access level is imparted, and
the third storage unit stores the second processed data in a state where the related access level is imparted.

### Supplementary Note 7

The data providing system according to any one of supplementary notes 1 to 6, wherein the data providing unit,
when a plurality of the access levels are assigned to the customer, generates, for each of a plurality of the access levels, a menu indicating data related to the access level among pieces of the data, and presents a plurality of the menus to the customer, and
provides the customer with data related to the menu selected by the customer from among a plurality of the menus.

### Supplementary Note 8

A data providing apparatus comprising:
a processing unit configured to generate processed data by performing processing on sensing data acquired by performing optical fiber sensing in an optical fiber sensing unit;
a level imparting unit configured to impart an access level according to a processing stage to each piece of data being included in the sensing data and the processed data; and
a data providing unit configured to provide each piece of the data to a customer related to the access level.

### Supplementary Note 9

The data providing apparatus according to supplementary note 8, wherein the processing includes first-stage processing and second-stage processing,
the processing unit includes a first processing unit configured to generate first processed data by performing the first-stage processing on the sensing data, and a second processing unit configured to generate second processed data by performing the second-stage processing on the first processed data, and
the processed data include the first processed data and the second processed data.

### Supplementary Note 10

The data providing apparatus according to supplementary note 9, further comprising a storage unit configured to store the sensing data, the first processed data, and the second processed data.

### Supplementary Note 11

The data providing apparatus according to supplementary note 10, wherein the storage unit stores the sensing data, the first processed data, and the second processed data in a state where the related access levels are imparted.

### Supplementary Note 12

The data providing apparatus according to supplementary note 9, further comprising:
a first storage unit configured to store the sensing data;
a second storage unit configured to store the first processed data; and
a third storage unit configured to store the second processed data.

### Supplementary Note 13

The data providing apparatus according to supplementary note 12, wherein
the first storage unit stores the sensing data in a state where the related access level is imparted,
the second storage unit stores the first processed data in a state where the related access level is imparted, and
the third storage unit stores the second processed data in a state where the related access level is imparted.

### Supplementary Note 14

The data providing apparatus according to any one of supplementary notes 8 to 13, wherein the data providing unit,
when a plurality of the access levels are assigned to the customer, generates, for each of a plurality of the access levels, a menu indicating data related to the access level among pieces of the data, and presents a plurality of the menus to the customer, and
provides the customer with data related to the menu selected by the customer from among a plurality of the menus.

### Supplementary Note 15

A data providing method performed by a data providing apparatus, the data providing method comprising:
a processing step of generating processed data by performing processing on sensing data acquired by performing optical fiber sensing in an optical fiber sensing unit;
a level imparting step of imparting an access level according to a processing stage to each piece of data being included in the sensing data and the processed data; and
a data providing step of providing each piece of the data to a customer related to the access level.

### Supplementary Note 16

The data providing method according to supplementary note 15, wherein
the processing includes first-stage processing and second-stage processing,
the processing step includes a first processing step of generating first processed data by performing the first-stage processing on the sensing data, and a second processing step of generating second processed data by performing the second-stage processing on the first processed data, and
the processed data include the first processed data and the second processed data.

### Supplementary Note 17

The data providing method according to supplementary note 16, further comprising a storage step of storing the sensing data, the first processed data, and the second processed data in a storage unit.

### Supplementary Note 18

The data providing method according to supplementary note 17, wherein the storage step includes storing the sensing data, the first processed data, and the second processed data in the storage unit in a state where the related access levels are imparted.

### Supplementary Note 19

The data providing method according to supplementary note 16, further comprising:
a first storage step of storing the sensing data in a first storage unit;
a second storage step of storing the first processed data in a second storage unit; and
a third storage step of storing the second processed data in a third storage unit.

### Supplementary Note 20

The data providing method according to supplementary note 19, wherein
the first storage step includes storing the sensing data in the first storage unit in a state where the related access level is imparted,
the second storage step includes storing the first processed data in the second storage unit in a state where the related access level is imparted, and
the third storage step includes storing the second processed data in the third storage unit in a state where the related access level is imparted.

### Supplementary Note 21

The data providing method according to any one of supplementary notes 15 to 20, wherein the data providing step includes:
when a plurality of the access levels are assigned to the customer, generating, for each of a plurality of the access levels, a menu indicating data related to the access level among pieces of the data, and presenting a plurality of the menus to the customer; and
providing the customer with data related to the menu selected by the customer from among a plurality of the menus.

### Supplementary Note 22

A non-transitory computer-readable medium storing a program for causing a computer to execute:
a processing procedure of generating processed data by performing processing on sensing data acquired by performing optical fiber sensing in an optical fiber sensing unit;
a level imparting procedure of imparting an access level according to a processing stage to each piece of data being included in the sensing data and the processed data; and
a data providing procedure of providing each piece of the data to a customer related to the access level.

### REFERENCE SIGNS LIST

1, 1A, 1B DATA PROVIDING SYSTEM
10 OPTICAL FIBER SENSING UNIT
20 DATA PROVIDING APPARATUS
21 PROCESSING UNIT
22 LEVEL IMPARTING UNIT
23, 231 to 233 STORAGE UNIT
24 DATA PROVIDING UNIT
30 OPTICAL FIBER CABLE
40 COMPUTER
41 PROCESSOR
42 MEMORY
43 STORAGE
44 INPUT/OUTPUT INTERFACE
441 DISPLAY DEVICE
442 INPUT DEVICE
443 SOUND OUTPUT DEVICE
45 COMMUNICATION INTERFACE

What is claimed is:

1. A data providing system comprising:
at least one memory storing instructions, and at least one processor configured to execute the instructions to;
acquire sensing data by performing optical fiber sensing;
generate processed data by performing processing on the sensing data;
impart an access level according to a processing stage to each piece of data being included in the sensing data and the processed data; and
provide each piece of the data to a customer related to the access level.

2. The data providing system according to claim 1, wherein
the processing includes first-stage processing and second-stage processing,
the at least one processor is configured to execute the instructions to generate first processed data by performing the first-stage processing on the sensing data, and generate second processed data by performing the second-stage processing on the first processed data, and the processed data include the first processed data and the second processed data.

3. The data providing system according to claim 2, wherein
the at least one memory further stores the sensing data, the first processed data, and the second processed data.

4. The data providing system according to claim 3, wherein the at least one memory stores the sensing data, the first processed data, and the second processed data in a state where the related access levels are imparted.

5. The data providing system according to claim 2, wherein the at least one memory includes:
a first memory configured to store the sensing data;
a second memory configured to store the first processed data; and
a third memory configured to store the second processed data.

6. The data providing system according to claim 5, wherein
the first memory stores the sensing data in a state where the related access level is imparted,
the second memory stores the first processed data in a state where the related access level is imparted, and
the third memory stores the second processed data in a state where the related access level is imparted.

7. The data providing system according to claim 1, wherein the at least one processor is configured to execute the instructions to,
when a plurality of the access levels are assigned to the customer, generate, for each of a plurality of the access levels, a menu indicating data related to the access level among pieces of the data, and presents a plurality of the menus to the customer, and
provide the customer with data related to the menu selected by the customer from among a plurality of the menus.

8. A data providing apparatus comprising:
at least one memory storing instructions, and
at least one processor configured to execute the instructions to;
generate processed data by performing processing on sensing data acquired by performing optical fiber sensing in an optical fiber sensing unit;
impart an access level according to a processing stage to each piece of data being included in the sensing data and the processed data; and
provide each piece of the data to a customer related to the access level.

9. The data providing apparatus according to claim 8, wherein
the processing includes first-stage processing and second-stage processing,
the at least one processor is configured to execute the instructions to generate first processed data by performing the first-stage processing on the sensing data, and generate second processed data by performing the second-stage processing on the first processed data, and
the processed data include the first processed data and the second processed data.

10. The data providing apparatus according to claim 9, wherein
the at least one memory further stores the sensing data, the first processed data, and the second processed data.

11. The data providing apparatus according to claim 10, wherein the at least one memory stores the sensing data, the first processed data, and the second processed data in a state where the related access levels are imparted.

12. The data providing apparatus according to claim 9, wherein the at least one memory includes:
a first memory configured to store the sensing data;
a second memory configured to store the first processed data; and
a third memory configured to store the second processed data.

13. The data providing apparatus according to claim 12, wherein
the first memory stores the sensing data in a state where the related access level is imparted,
the second memory stores the first processed data in a state where the related access level is imparted, and
the third memory stores the second processed data in a state where the related access level is imparted.

14. The data providing apparatus according to claim 8,
wherein the at least one processor is configured to execute the instructions to,
when a plurality of the access levels are assigned to the customer, generate, for each of a plurality of the access levels, a menu indicating data related to the access level among pieces of the data, and presents a plurality of the menus to the customer, and
provide the customer with data related to the menu selected by the customer from among a plurality of the menus.

15. A data providing method performed by a data providing apparatus, the data providing method comprising:
a processing step of generating processed data by performing processing on sensing data acquired by performing optical fiber sensing in an optical fiber sensing unit;
a level imparting step of imparting an access level according to a processing stage to each piece of data being included in the sensing data and the processed data; and
a data providing step of providing each piece of the data to a customer related to the access level.

16. The data providing method according to claim 15, wherein
the processing includes first-stage processing and second-stage processing,
the processing step includes a first processing step of generating first processed data by performing the first-stage processing on the sensing data, and a second processing step of generating second processed data by performing the second-stage processing on the first processed data, and
the processed data include the first processed data and the second processed data.

17. The data providing method according to claim 16, further comprising a storage step of storing the sensing data, the first processed data, and the second processed data in a memory.

18. The data providing method according to claim 17, wherein the storage step includes storing the sensing data, the first processed data, and the second processed data in the memory in a state where the related access levels are imparted.

19. The data providing method according to claim 16, further comprising:
a first storage step of storing the sensing data in a first memory;
a second storage step of storing the first processed data in a second memory; and
a third storage step of storing the second processed data in a third memory.

20. The data providing method according to claim 19, wherein
the first storage step includes storing the sensing data in the first memory in a state where the related access level is imparted,
the second storage step includes storing the first processed data in the second memory in a state where the related access level is imparted, and
the third storage step includes storing the second processed data in the third memory in a state where the related access level is imparted.

21. (canceled)
